(19) United States
(12) Patent Application Publication
(10) Pub. No.: US 2026/0103180 A1
(43) Pub. Date: Apr. 16, 2026

(54) METHODS AND SYSTEM TO PREPARE VEHICLE FOR PERFORMANCE MODE

(71) Applicant: Ford Global Technologies, LLC, Dearborn, MI (US)

(72) Inventors: Andrew E. Burt, Royal Oak, MI (US); Brendan Diamond, Naples, FL (US); Keith Weston, Canton, MI (US)

(21) Appl. No.: 18/917,357

(22) Filed: Oct. 16, 2024

(51) Int. Cl. B60W 20/13; B60W 10/06; B60W 10/08; B60W 50/10

(52) U.S. Cl. CPC B60W 20/13; B60W 10/06; B60W 10/08; B60W 50/10; B60W 2540/10

(57) ABSTRACT

Systems and methods for adjusting electric machine torque or power according to a position of a human operated input device other than a driver demand pedal are described. In one example, the human operated input device may be a pushbutton or a lever. Electric charge or mechanical torque or power may be generated via the electric machine in response to a position of the human operated input device.

### FIELD

The present description relates to methods and a system for adjusting operation of a hybrid vehicle responsive to human input.

### BACKGROUND

A hybrid vehicle may include both an internal combustion engine and an electric machine. The internal combustion engine and the electric machine may operate as propulsion sources. Additionally, the electric machine may operate to generate charge that may be applied to recharge a traction battery. The electric machine may switch back and forth from a charge generating mode to a mechanical torque or power generating mode. The hybrid vehicle may receive input from a driver demand pedal, and depending on driver demand as determined from a position of the driver demand pedal, the electric machine may switch between charge generating mode and mechanical torque or power generating mode. However, even though it may be desirable for a vehicle to respond to a driver demand input, the vehicle operator may wish to have additional control authority over the vehicle.

It may be understood that the summary above is provided to introduce in simplified form a selection of concepts that are further described in the detailed description. It is not meant to identify key features of the claimed subject matter, the scope of which is defined specifically by the claims that follow the detailed description. Furthermore, the claimed subject matter is not constrained to implementations that solve any disadvantages noted above or in any part of this disclosure.

### BRIEF DESCRIPTION OF THE DRAWINGS

The advantages described herein will be more fully understood by reading an example of an embodiment, referred to herein as the Detailed Description, when taken alone or with reference to the drawings, where:

FIG. 1 is a schematic diagram of an engine;

FIG. 2 is a schematic diagram of a vehicle and vehicle driveline;

FIG. 3 shows an example vehicle operating sequence where a hybrid vehicle responds to a position of human operated input device;

FIG. 4 shows an example method for controlling operation of a hybrid vehicle in response to two different human operated input devices; and

FIGS. 5-10 show examples for adjusting actuators according to human input to a human operated input device.

### DETAILED DESCRIPTION

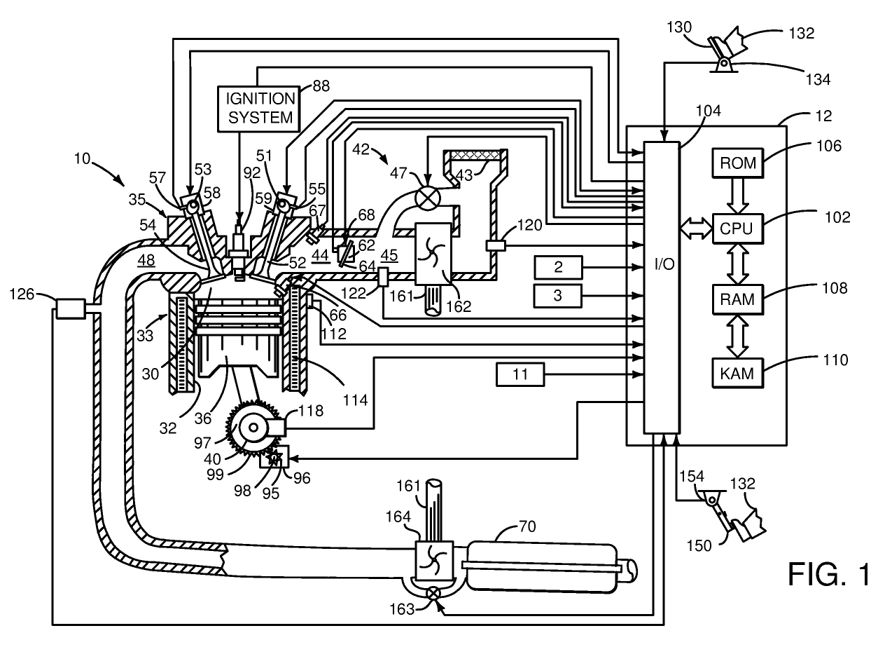

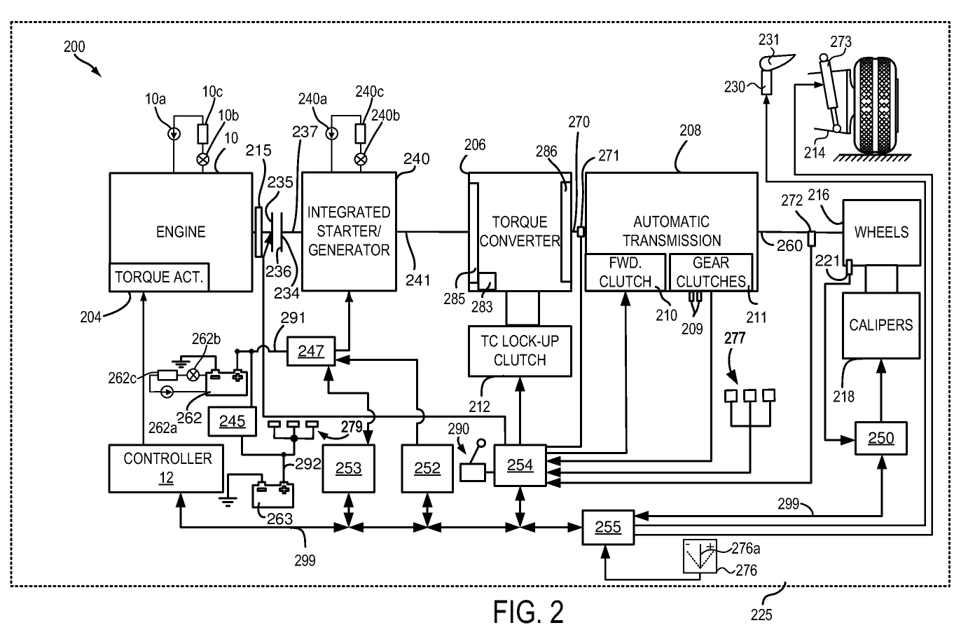

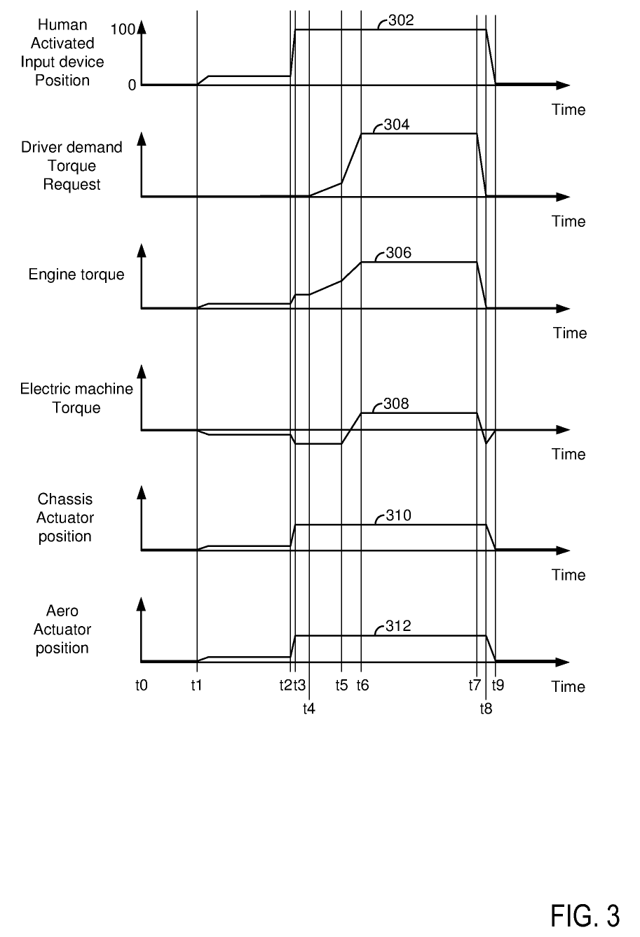

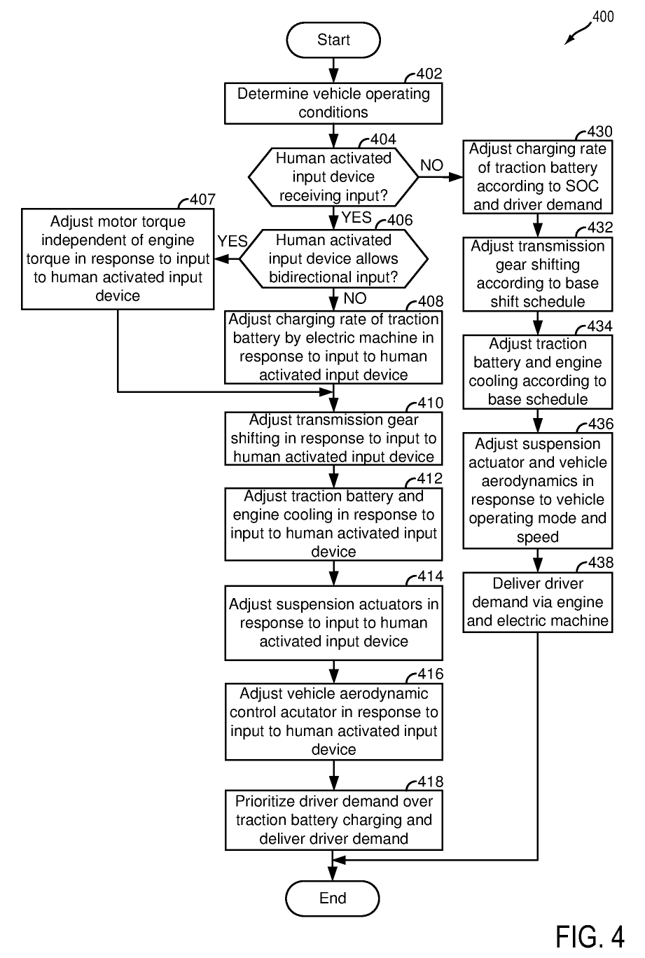

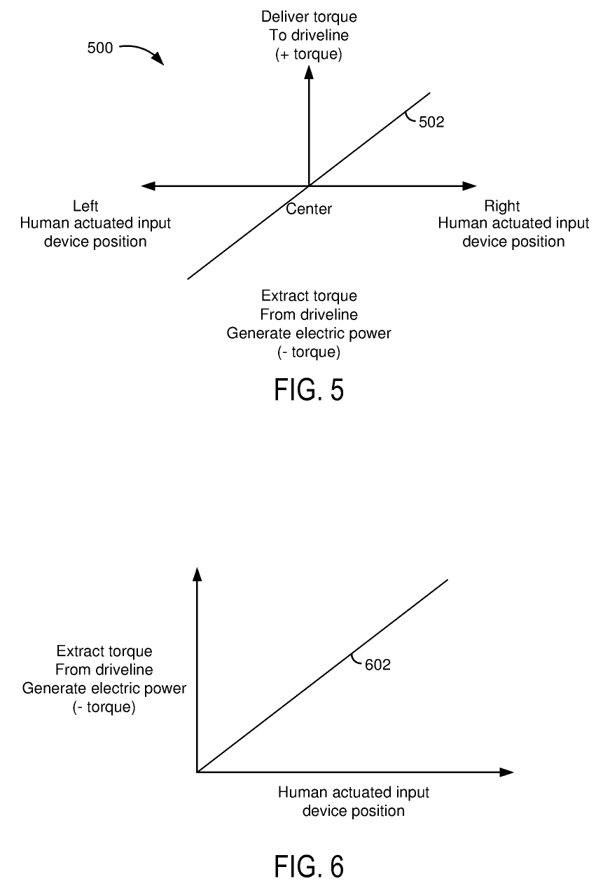

The present description is related to controlling operation of a hybrid vehicle in response to two human operated input devices. The first of the two human operated input devices is a driver demand pedal and the second of the two human operated input devices may be a lever, pushbutton, or other device configured to receive input from a human hand. The second human operated input device may provide independent control over one or more actuators in a vehicle performance enhancement mode. An engine of the type that is shown in FIG. 1 may be part of a hybrid vehicle. The engine may be part of a hybrid vehicle as shown in FIG. 2, or alternatively, in a different hybrid vehicle configuration. An example vehicle operating sequence according to the method of FIG. 4 is shown in FIG. 3. FIG. 4 shows a flowchart of a method for operating a hybrid vehicle that includes two human operated input devices. FIGS. 5-10 show examples of how various actuators may be adjusted in response to human input to a second human operated input device.

A hybrid vehicle may receive input from a human via a driver demand pedal. Modes of the hybrid vehicle may change according to a driver demand torque or power that is determined from the driver demand pedal position. However, since the driver demand pedal adjusts driver demand torque or power according to the position of the driver demand pedal, adjustments of actuators that are based on driver demand pedal position are not adjusted independent of driver demand pedal position. Consequently, operation of the vehicle’s electric propulsion source is directly tied to the position of the driver demand pedal. Therefore, operation of the vehicle’s electric propulsion source may be constrained with respect to operating modes that the electric propulsion source may enter based on the position of the driver demand pedal.

The inventors herein have recognized the above-mentioned issues and have developed a method for operating a hybrid vehicle, comprising: receiving input to a controller via a first human operated input device; receiving input to the controller via a second human operated input device; adjusting a driver demand torque or power via the controller in response to output of the first human operated input device; and adjusting torque or power of an electric machine via the controller proportionate to an output of the second human operated input device.

By adjusting torque or power of an electric machine via a controller proportionate to an output of a human operated input device that is other than a driver demand pedal, it may be possible to provide the technical result of increasing vehicle driveline operational flexibility. Increasing vehicle driveline operational flexibility may allow a higher rate of battery charging as compared to if the vehicle adjusts operation of the electric machine in response to a sole operator input device, such as a driver demand pedal. Further, the electric machine may be controlled to operate in a mechanical power or torque mode, or alternatively, in a charge generating mode according to a position of a human operated input device that is other than a driver demand pedal. Thus, operational flexibility of hybrid vehicle operation may be increased via including a second human operated input device that is a basis for adjusting operation of an electric machine.

The present description may provide several advantages. In particular, the approach may increase vehicle operation flexibility by allowing the electric machine to be operated in different modes according to a position of a human operated input device that is other than a driver demand pedal. Further, the approach may allow a user to increase vehicle traction battery charging so that higher vehicle performance may be achieved as compared to it battery state of charge is low. In addition, the approach may decouple electric machine operation from driver demand pedal position, at least during some conditions, so that the electric machine may be controlled independent of a driver demand torque or power providing additional driveline control flexibility.

The above advantages and other advantages, and features of the present description will be readily apparent from the following Detailed Description when taken alone or in connection with the accompanying drawings.

Referring to FIG. 1, internal combustion engine 10, comprising a plurality of cylinders, one cylinder of which is shown in FIG. 1, is controlled by electronic engine controller 12. The controller 12 receives signals from the various sensors shown in FIGS. 1 and 2. The controller employs the actuators shown in FIGS. 1 and 2 to adjust engine and driveline or powertrain operation based on the received signals and instructions stored in memory of controller 12.

Engine 10 is comprised of cylinder head 35 and block 33, which include combustion chamber 30 and cylinder walls 32. Piston 36 is positioned therein and reciprocates via a connection to crankshaft 40. Flywheel 97 and ring gear 99 are coupled to crankshaft 40. Optional starter 96 (e.g., low voltage (operated with less than 30 volts) electric machine) includes pinion shaft 98 and pinion gear 95. Pinion shaft 98 may selectively advance pinion gear 95 to engage ring gear 99. Optional starter 96 may be directly mounted to the front of the engine or the rear of the engine. In some examples, starter 96 may selectively supply power to crankshaft 40 via a chain. In addition, starter 96 is in a base state when not engaged to the engine crankshaft 40 and flywheel ring gear 99. Starter 96 may be referred to as a flywheel starter.

Combustion chamber 30 is shown communicating with intake manifold 44 and exhaust manifold 48 via respective intake valve 52 and exhaust valve 54. Each intake and exhaust valve may be operated by an intake cam 51 and an exhaust cam 53. The position of intake cam 51 may be determined by intake cam sensor 55. The position of exhaust cam 53 may be determined by exhaust cam sensor 57. Intake valve 52 may be selectively activated and deactivated by valve activation device 59. Exhaust valve 54 may be selectively activated and deactivated by valve activation device 58. Valve activation devices 58 and 59 may be electro-mechanical devices.

Direct fuel injector 66 is shown positioned to inject fuel directly into combustion chamber 30, which is known to those skilled in the art as direct injection. Port fuel injector 67 is shown positioned to inject fuel into the intake port of combustion chamber 30, which is known to those skilled in the art as port injection. Fuel injectors 66 and 67 deliver liquid fuel in proportion to pulse widths provided by controller 12. Fuel is delivered to fuel injectors 66 and 67 by a fuel system (not shown) including a fuel tank, fuel pump, and fuel rail (not shown).

In addition, intake manifold 44 is shown communicating with turbocharger compressor 162 and engine air intake 42. In other examples, compressor 162 may be a supercharger compressor. Shaft 161 mechanically couples turbocharger turbine 164 to turbocharger compressor 162. Optional electronic throttle 62 adjusts a position of throttle plate 64 to control air flow from compressor 162 to intake manifold 44. Pressure in boost chamber 45 may be referred to a throttle inlet pressure since the inlet of throttle 62 is within boost chamber 45. The throttle outlet is in intake manifold 44. In some examples, throttle 62 and throttle plate 64 may be positioned between intake valve 52 and intake manifold 44 such that throttle 62 is a port throttle. Compressor recirculation valve 47 may be selectively adjusted to a plurality of positions between fully open and fully closed. Waste gate 163 may be adjusted via controller 12 to allow exhaust gases to selectively bypass turbine 164 to control the speed of compressor 162. Air filter 43 cleans air entering engine air intake 42.

Distributorless ignition system 88 provides an ignition spark to combustion chamber 30 via spark plug 92 in response to controller 12. Universal Exhaust Gas Oxygen (UEGO) sensor 126 is shown coupled to exhaust manifold 48 upstream of three-way catalyst 70. Alternatively, a two-state exhaust gas oxygen sensor may be substituted for UEGO sensor 126.

Catalyst 70 may include multiple bricks and a three-way catalyst coating, in one example. In another example, multiple emission control devices, each with multiple bricks, can be used.

Controller 12 is shown in FIG. 1 as a conventional microcomputer including: microprocessor unit 102, input/output ports 104, read-exclusive memory 106 (e.g., non-transitory memory), random access memory 108, keep alive memory 110, and a conventional data bus. Controller 12 is shown receiving various signals from sensors coupled to engine 10, in addition to those signals previously discussed, including: engine coolant temperature (ECT) from temperature sensor 112 coupled to cooling sleeve 114; a position sensor 134 coupled to a driver demand pedal 130 (e.g., a human operated input device) for sensing force applied by human driver 132; a position caliper pedal position sensor 154 coupled to caliper pedal 150 (e.g., a human/machine interface) for sensing force applied by human driver 132, a measurement of engine manifold pressure (MAP) from pressure sensor 122 coupled to intake manifold 44; an engine position sensor from an engine position sensor 118 sensing crankshaft 40 position; a measurement of air mass entering the engine from sensor 120; and a measurement of throttle position from sensor 68. Barometric pressure may also be sensed (sensor not shown) for processing by controller 12. In a preferred aspect of the present description, engine position sensor 118 produces a predetermined number of equally spaced pulses each revolution of the crankshaft from which engine speed (RPM) can be determined.

Controller 12 may also receive input from human/machine interface 11. A request to start or stop the engine or vehicle may be generated via a human and input to the human/machine interface 11. The human/machine interface 11 may be a touch screen display, pushbutton, key switch or other known device. Controller 12 may also receive navigation and GPS data (e.g., locations of lights, signs, roads, etc.) from GPS receiver/navigation system 2. Controller 12 may interface with other vehicles to receive traffic data (e.g., locations of other vehicles, traffic flow, etc.) from connected vehicle interface 3.

During operation, each cylinder within engine 10 typically undergoes a four stroke cycle: the cycle includes the intake stroke, compression stroke, expansion stroke, and exhaust stroke. During the intake stroke, generally, the exhaust valve 54 closes and intake valve 52 opens. Air is introduced into combustion chamber 30 via intake manifold 44, and piston 36 moves to the bottom of the cylinder so as to increase the volume within combustion chamber 30. The position at which piston 36 is near the bottom of the cylinder and at the end of its stroke (e.g. when combustion chamber 30 is at its largest volume) is typically referred to by those of skill in the art as bottom dead center (BDC).

During the compression stroke, intake valve 52 and exhaust valve 54 are closed. Piston 36 moves toward the cylinder head so as to compress the air within combustion chamber 30. The point at which piston 36 is at the end of its stroke and closest to the cylinder head (e.g. when combustion chamber 30 is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as spark plug 92, resulting in combustion.

During the expansion stroke, the expanding gases push piston 36 back to BDC. Crankshaft 40 converts piston movement into a rotational power of the rotary shaft. Finally, during the exhaust stroke, the exhaust valve 54 opens to release the combusted air-fuel mixture to exhaust manifold 48 and the piston returns to TDC. Note that the above is shown merely as an example, and that intake and exhaust valve opening and/or closing timings may vary, such as to provide positive or negative valve overlap, late intake valve closing, or various other examples.

FIG. 2 is a block diagram of a vehicle 225 including a powertrain or driveline 200. The driveline of FIG. 2 includes engine 10 shown in FIG. 1. Driveline 200 is shown including vehicle system controller 255, engine controller 12, electric machine controller 252, transmission controller 254, energy storage device controller 253, and caliper controller 250. The controllers may communicate over controller area network (CAN) 299. Each of the controllers may provide information to other controllers such as power output not to exceed thresholds (e.g., power output of the device or component being controlled not to be exceeded), power input thresholds (e.g., power input of the device or component being controlled not to be exceeded), power output of the device being controlled, sensor and actuator data, diagnostic information (e.g., information regarding a degraded transmission, information regarding a degraded engine, information regarding a degraded electric machine, information regarding degraded calipers). Further, the vehicle system controller 255 may provide commands to and/or receive input from engine controller 12, electric machine controller 252, transmission controller 254, caliper controller 250, suspension actuators 273, aerodynamic actuators 230, and human operated input device 276 to achieve human driver input requests and other requests that are based on vehicle operating conditions.

For example, in response to a driver releasing a driver demand pedal and vehicle speed, vehicle system controller 255 may request a desired wheel power or a wheel power level to provide a desired rate of vehicle speed reduction. The requested desired wheel power may be provided by vehicle system controller 255 requesting a first slowing power from electric machine controller 252 and a second slowing power from engine controller 12, the first and second powers providing a desired driveline slowing power at vehicle wheels 216. Vehicle system controller 255 may also request a friction caliber power via caliper controller 250. The slowing and caliper powers may be referred to as negative powers since they slow driveline and wheel rotation. Positive power may maintain or increase speed of the driveline and wheel rotation.

In other examples, the partitioning of controlling driveline devices may be partitioned differently than is shown in FIG. 2. For example, a single controller may take the place of vehicle system controller 255, engine controller 12, electric machine controller 252, transmission controller 254, and caliper controller 250. Alternatively, the vehicle system controller 255 and the engine controller 12 may be a single unit while the electric machine controller 252, the transmission controller 254, and the caliper controller 250 are standalone controllers.

In this example, driveline 200 may be powered by engine 10 and ISG 240 (e.g., an electric machine). Engine 10 may be started with an engine starting system shown in FIG. 1 or via driveline integrated starter/generator (ISG) 240 also known as an integrated starter/generator. Driveline ISG 240 (e.g., high voltage (operated with greater than 30 volts) electrical machine) may also be referred to as an electric machine, motor, and/or generator. Further, power of engine 10 may be adjusted via power actuator 204, such as a fuel injector, throttle, etc.

ISG 240 may provide a negative torque to driveline 200 consuming mechanical power when charging higher voltage electric energy storage device 262 (e.g., a traction battery). ISG 240 may also provide a positive torque generating mechanical power to rotate driveline 200 via energy supplied by higher voltage electric energy storage device 262. In one example, higher voltage electric energy storage device 262 may output a higher voltage (e.g., 48 volts) than electric energy storage device 263 (e.g., 12 volts). DC/DC converter 245 may allow exchange of electrical energy between high voltage bus 291 and low voltage bus 292. High voltage bus 291 is electrically coupled to higher voltage electric energy storage device 262. Low voltage bus 292 is electrically coupled to lower voltage electric energy storage device 263 and sensors/actuators/accessories 279. Electrical accessories 279 may include but are not constrained to front and rear windshield resistive heaters, vacuum pumps, climate control fans, and lights. Inverter 247 converts DC power to AC power and vice-versa to enable power to be transferred between ISG 240 and higher voltage electric energy storage device 262.

An engine output power may be transmitted to an input or first side of driveline disconnect clutch 235 through dual mass flywheel 215. Disconnect clutch 236 may be electrically or hydraulically actuated. The downstream or second side 234 of disconnect clutch 236 is shown mechanically coupled to ISG input shaft 237.

ISG 240 may be operated to provide power to driveline 200 or to convert driveline power into electrical energy to be stored in higher voltage electric energy storage device 262 in a regeneration mode. ISG 240 is in electrical communication with higher voltage electric energy storage device 262. ISG 240 has a higher output power capacity than starter 96 shown in FIG. 1. Further, ISG 240 directly drives driveline 200 or is directly driven by driveline 200. There are no gears or chains to couple ISG 240 to driveline 200. Rather, ISG 240 rotates at the same rate as driveline 200. Higher voltage electrical energy storage device 262 may be a battery, capacitor, or inductor. The downstream side of ISG 240 is mechanically coupled to the impeller 285 of torque converter 206 via shaft 241. The upstream side of the ISG 240 is mechanically coupled to the disconnect clutch 236. ISG 240 may provide a positive power or a negative power to driveline 200 via operating as a motor or generator as instructed by electric machine controller 252.

Torque converter 206 includes a turbine 286 to output power to input shaft 270. Input shaft 270 mechanically couples torque converter 206 to automatic transmission 208. Torque converter 206 also includes a torque converter bypass lock-up clutch 212 (TCC). Power is directly transferred from impeller 285 to turbine 286 when TCC is locked. TCC is electrically operated by controller 254. Alternatively, TCC may be hydraulically locked. In one example, the torque converter may be referred to as a component of the transmission.

When torque converter bypass lock-up clutch 212 is fully disengaged, torque converter 206 transmits engine power to automatic transmission 208 via fluid transfer between the torque converter turbine 286 and torque converter impeller 285, thereby enabling torque multiplication. In contrast, when torque converter bypass lock-up clutch 212 is fully engaged, the engine output power is directly transferred via the torque converter clutch to an input shaft 270 of transmission 208. Alternatively, the torque converter bypass lock-up clutch 212 may be partially engaged, thereby enabling the amount of power directly transferred to the transmission to be adjusted. The transmission controller 254 may be configured to adjust the amount of power transmitted by the torque converter bypass lock-up clutch 212 via adjusting the torque converter lock-up clutch in response to various engine operating conditions, or based on a driver-based engine operation request.

Torque converter 206 also includes pump 283 that pressurizes fluid to operate disconnect clutch 236, forward clutch 210, and gear clutches 211. Pump 283 is driven via impeller 285, which rotates at a same speed as ISG 240.

Automatic transmission 208 includes gear clutches (e.g., gears 1-10) 211 and forward clutch 210. Automatic transmission 208 is a fixed ratio transmission. Alternatively, transmission 208 may be a continuously variable transmission that has a capability of simulating a fixed gear ratio transmission and fixed gear ratios. The gear clutches 211 and the forward clutch 210 may be selectively engaged to change a ratio of an actual total number of turns of input shaft 270 to an actual total number of turns of wheels 216. Gear clutches 211 may be engaged or disengaged via adjusting fluid supplied to the clutches via shift control solenoid valves 209. Power output from the automatic transmission 208 may also be relayed to wheels 216 to propel the vehicle via output shaft 260. Specifically, automatic transmission 208 may transfer an input driving power at the input shaft 270 responsive to a vehicle traveling condition before transmitting an output driving power to the wheels 216. Transmission controller 254 selectively activates or engages torque converter bypass lock-up clutch 212, gear clutches 211, and forward clutch 210. Transmission controller also selectively deactivates or disengages torque converter bypass lock-up clutch 212, gear clutches 211, and forward clutch 210.

A frictional force may be applied to wheels 216 by engaging friction wheel calipers 218. In one example, friction wheel calipers 218 may be engaged in response to a human driver pressing their foot on a caliper pedal (not shown) and/or in response to instructions within caliper controller 250. Further, caliper controller 250 may apply calipers 218 in response to information and/or requests made by vehicle system controller 255. In the same way, a frictional force may be reduced to wheels 216 by disengaging wheel calipers 218 in response to the human driver releasing their foot from a caliper pedal, caliper controller instructions, and/or vehicle system controller instructions and/or information. For example, vehicle calipers may apply a frictional force to wheels 216 via controller 250 as part of an automated vehicle stopping procedure. A vehicle slowing torque may be determined as a function of caliper pedal position.

In response to a request to increase a speed of vehicle 225, vehicle system controller may obtain a driver demand power or power request from a driver demand pedal or other device. Vehicle system controller 255 then allocates a fraction of the requested driver demand power to the engine and the remaining fraction to the ISG. Vehicle system controller 255 requests the engine power from engine controller 12 and the ISG power from electric machine controller 252. If the ISG power plus the engine power is less than a transmission input power threshold (e.g., a threshold value not to be exceeded), the power is delivered to torque converter 206 which then relays at least a fraction of the requested power to transmission input shaft 270. Transmission controller 254 selectively locks torque converter bypass lock-up clutch 212 and engages gears via gear clutches 211 in response to shift schedules and TCC lockup schedules that may be based on input shaft power and vehicle speed. In some conditions when it may be desired to charge higher voltage electric energy storage device 262, a charging power (e.g., a negative ISG power where the ISG consumes mechanical power from the driveline) may be requested while a non-zero driver demand power is present. Vehicle system controller 255 may request increased engine power to overcome the charging power to meet the driver demand power.

In response to a request to reduce a speed of vehicle 225 and provide regenerative vehicle slowing, vehicle system controller may provide a negative desired wheel power (e.g., desired or requested driveline wheel power) based on vehicle speed and caliper pedal position. Vehicle system controller 255 then allocates a fraction of the negative desired wheel power to the ISG 240 and the engine 10. Vehicle system controller may also allocate a portion of the requested vehicle slowing power to friction calipers 218 (e.g., desired friction caliper wheel power). Further, vehicle system controller may notify transmission controller 254 that the vehicle is in regenerative vehicle slowing mode so that transmission controller 254 shifts gears 211 based on a specific shifting schedule to increase regeneration efficiency. Engine 10 and ISG 240 may supply a negative power to transmission input shaft 270 (consuming mechanical power from the driveline), but negative power provided by ISG 240 and engine 10 may be constrained by transmission controller 254, which outputs a transmission input shaft negative power threshold (e.g., not to be exceeded threshold value). Further, negative power of ISG 240 may be constrained (e.g., constrained to less than a threshold negative threshold power) based on operating conditions of higher voltage electric energy storage device 262, by vehicle system controller 255, or electric machine controller 252. Any portion of desired negative wheel power that may not be provided by ISG 240 because of transmission or ISG constraints may be allocated to engine 10 and/or friction calipers 218 so that the desired wheel power is provided by a combination of negative power (e.g., mechanical power absorbed from the driveline) via friction calipers 218, engine 10, and ISG 240.

Cooling of engine 10, ISG 240, and higher voltage electric energy storage device 262 may be controlled via one or more of the controllers mentioned herein. For example, vehicle system controller 255 may command an increase or decrease in coolant flow to engine 10 via adjusting a position of engine coolant flow control valve 10b or speed of engine coolant pump 10a. Engine coolant may be cooled via engine heat exchanger 10c. In addition, vehicle system controller 255 may command an increase or decrease in coolant flow to ISG 240 via adjusting a position of ISG coolant flow control valve 240b or speed of ISG coolant pump 240a. ISG coolant may be cooled via ISG heat exchanger 240c. Further, vehicle system controller 255 may command an increase or decrease in coolant flow to higher voltage electric energy storage device 262 via adjusting a position of battery coolant flow control valve 262b or speed of battery coolant pump 262a. Battery coolant may be cooled via battery heat exchanger 262c. In one example, vehicle system controller 255 may adjust coolant flow to ISG 240, engine 10, and/or higher voltage electric energy storage device via coolant flow control valves and pump speed as previously mentioned according to a position of human operated input device 276. Human operated input device 276 includes a lever 276a that returns to a center position when there is no human input. Lever 276a is shown in its center position in FIG. 2. Lever 276a may be moved to the left as indicated by dashed lines and the “-“ sign to request negative or reduced output of a device. Lever 276a may be moved to the right as indicated by dashed lines and the “+“ sign to request positive or increased output of a device. While this example shows human operated input device 276 as a lever operated device, in other examples, human operated input device 276 may take the form of a pushbutton or other known type of input device.

One or more of the controllers described herein may also adjust a position of aerodynamic actuator 230 to adjust a position of aerodynamic control device 231 (e.g., wing, shroud, air dam, etc.). Further, one or more controllers described herein may adjust operation and/or a position of suspension actuator 273 (e.g., shock absorber, spring, etc.) to adjust operation and/or a position of one or more vehicle suspension components 214. For example, vehicle system controller 255 may adjust a position or operation of aerodynamic actuator and/or suspension actuator 273 in response to a position of human operated input device 276.

Accordingly, power control of the various driveline components may be supervised by vehicle system controller 255 with local power control for the engine 10, transmission 208, ISG 240, and calipers 218 provided via engine controller 12, electric machine controller 252, transmission controller 254, and caliper controller 250.

As one example, an engine power output may be controlled by adjusting a combination of spark timing, fuel pulse width, fuel pulse timing, and/or air charge, by controlling throttle opening and/or valve timing, valve lift and boost for turbo- or super-charged engines. In the case of a diesel engine, controller 12 may control the engine power output by controlling a combination of fuel pulse width, fuel pulse timing, and air charge. Engine slowing power or negative engine power may be provided by rotating the engine with the engine generating power that is insufficient to rotate the engine. Thus, the engine may generate a vehicle slowing power via operating at a low power while combusting fuel, with one or more cylinders deactivated (e.g., not combusting fuel), or with all cylinders deactivated and while rotating the engine. The amount of engine slowing power may be adjusted via adjusting engine valve timing. Engine valve timing may be adjusted to increase or decrease engine compression work. Further, engine valve timing may be adjusted to increase or decrease engine expansion work. In all cases, engine control may be performed on a cylinder-by-cylinder basis to control the engine power output.

Electric machine controller 252 may control power output and electrical energy production from ISG 240 by adjusting current flowing to and from field and/or armature windings of ISG as is known in the art.

Transmission controller 254 receives transmission input shaft position via position sensor 271. Transmission controller 254 may convert transmission input shaft position into input shaft speed via differentiating a signal from position sensor 271 or counting a number of known angular distance pulses over a predetermined time interval. Transmission controller 254 may receive transmission output shaft torque from torque sensor 272. Alternatively, sensor 272 may be a position sensor or torque and position sensors. If sensor 272 is a position sensor, controller 254 may count shaft position pulses over a predetermined time interval to determine transmission output shaft velocity. Transmission controller 254 may also differentiate transmission output shaft velocity to determine transmission output shaft rate of speed change. Transmission controller 254, engine controller 12, and vehicle system controller 255, may also receive addition transmission information from sensors 277, which may include but are not constrained to pump output line pressure sensors, transmission hydraulic pressure sensors (e.g., gear clutch fluid pressure sensors), ISG temperature sensors, gear shift lever sensors, and ambient temperature sensors. Transmission controller 254 may also receive requested gear input from gear shift selector 290 (e.g., a human/machine interface device). Gear shift selector 290 may include positions for gears 1-N (where N is an upper gear number), D (drive), and P (park).

Caliper controller 250 receives wheel speed information via wheel speed sensor 221 and vehicle slowing requests from vehicle system controller 255. Caliper controller 250 may also receive caliper pedal position information from caliper pedal position sensor 154 shown in FIG. 1 directly or over CAN 299. Caliper controller 250 may provide vehicle slowing responsive to a wheel power command from vehicle system controller 255. Caliper controller 250 may also provide anti-lock and vehicle stability slowing to control vehicle slowing and stability. As such, caliper controller 250 may provide a wheel power threshold (e.g., a threshold negative wheel power not to be exceeded) to the vehicle system controller 255 so that negative ISG power does not cause the wheel power threshold to be exceeded. For example, if controller 250 issues a negative wheel power threshold of 50 N-m, ISG power is adjusted to provide less than 50 N-m (e.g., 49 N-m) of negative power at the wheels, including accounting for transmission gearing.

Thus, the system of FIGS. 1 and 2 provides for a system, comprising: a driver demand pedal; a human operated input device; an internal combustion engine; an electric machine; and one or more controllers including executable instructions stored in non-transitory memory that cause the one or more controllers to directly adjust operation of the electric machine (e.g., the controller commands the electric machine, which may include commanding an inverter) in response to output of the human operated input device and adjust operation of the internal combustion engine to generate a driver demand torque or power that is transferred to a vehicle’s wheels in response to a position of the driver demand pedal. In a first example, the system includes where adjusting operation of the electric machine includes adjusting an operating mode of the electric machine. In a second example that may include the first example, the system includes where the operating mode is selected from one of a torque or power generating mode and an electric charge generating mode. In a third example that may include one or both of the first and second examples, the system includes where adjusting operation of the electric machine includes adjusting output of the electric machine proportionate to a position of the human operated input device. In a fourth example that may include one or more of the first through third examples, the system further comprises additional instructions to additionally adjust operation of the internal combustion engine according to torque or power generated via the electric machine. In a fifth example that may include one or more of the first through fourth examples, the system includes where directly adjusting operation of the electric machine in response to output of the human operated input device includes the controller commanding an electric machine torque to increase charging of a traction battery as the human operated device is moved away from a base position. In a sixth example that may include one or more of the first through fifth examples, the system includes where adjusting operation of the internal combustion engine includes adjusting torque or power output of the internal combustion engine so as to produce a driver demand torque or power and an amount of power consumed via the electric machine.

Referring now to FIG. 3, a prophetic operating sequence according to the method of FIG. 4 and the system of FIGS. 1 and 2 is shown. The sequence of FIG. 3 may be provided via the system of FIGS. 1 and 2 in cooperation with the method of FIG. 4. The plots of FIG. 3 are time aligned. The vertical lines at times t0-t9 represent times of interest during the sequence.

The first plot from the top of FIG. 3 is a plot of a position a human operated input device versus time. The vertical axis represents a position of the human operated input device, and at the level of the horizontal axis, the human operated input device input is zero. The input to the human operated input device increases in the direction of the vertical axis arrow. The horizontal axis represents time and time increases from the left side of the figure to the right side of the figure. Solid line 302 represents the value of the input to the human operated input device.

The second plot from the top of FIG. 3 is a plot of a driver demand torque request versus time. The vertical axis represents a value of the driver demand torque request and the value of the driver demand torque request increases in the direction of the vertical axis arrow. The horizontal axis represents time and time increases from the left side of the figure to the right side of the figure. Solid line 304 represents the value of the driver demand torque request.

The third plot from the top of FIG. 3 is a plot of engine torque versus time. The vertical axis represents a value of the engine torque and the engine torque increases in the direction of the vertical axis arrow. The horizontal axis represents time and time increases from the left side of the figure to the right side of the figure. Solid line 306 represents the value of the engine torque.

The fourth plot from the top of FIG. 3 is a plot of an electric machine torque versus time. The vertical axis represents a value of the electric machine torque and the value of the electric machine torque increases in the direction of the vertical axis arrow. The horizontal axis represents time and time increases from the left side of the figure to the right side of the figure. Solid line 308 represents the value of the electric machine torque.

The fifth plot from the top of FIG. 3 is a plot of a suspension actuator position versus time. The vertical axis represents a value of the suspension actuator position and the suspension actuator position increases in the direction of the vertical axis arrow. The horizontal axis represents time and time increases from the left side of the figure to the right side of the figure. Solid line 310 represents the value of the suspension actuator position.

The sixth plot from the top of FIG. 3 is a plot of an aerodynamic actuator position versus time. The vertical axis represents a value of the aerodynamic actuator position and the aerodynamic actuator position increases in the direction of the vertical axis arrow. The horizontal axis represents time and time increases from the left side of the figure to the right side of the figure. Solid line 312 represents the value of the aerodynamic actuator position.

At time t0, there is no input to the human operated input device and the driver demand torque request is zero. Additionally, engine torque is zero and electric machine torque is zero. The suspension actuator is in its base position and the aerodynamic actuator is in its base position. Such conditions may be present when a hybrid vehicle is stopped.

At time t1, a human operator (not shown) adjusts a position of the human operated input device so that the human operated input device is moved to a partially activated position (e.g., 10% of full scale). The driver demand remains zero and engine torque output is increased to provide the torque that is consumed via the electric machine. The electric machine torque is negative so as to indicate that the electric machine is consuming mechanical power from the driveline to generate electric charge to charge the traction battery. The electric machine torque has been adjusted proportionate to the position of the human operated input device. Likewise, the suspension actuator and the aerodynamic actuator positions are adjusted proportionate to the position of the human operated input device.

At time t2, a human operator (not shown) again adjusts a position of the human operated input device so that the human operated input device is moved to a fully applied (e.g., 100% of full scale) position at time t3. The driver demand remains zero and engine torque output begins to increase further to provide the torque that is consumed via the electric machine. The electric machine remains in a charge generating mode where the electric machine charges the traction battery. The electric machine torque magnitude increases in the negative direction. The electric machine torque has been adjusted proportionate to the position of the human operated input device and the electric machine charges the traction battery at a higher rate. Likewise, the suspension actuator and the aerodynamic actuator positions are adjusted again proportionate to the position of the human operated input device. Engine torque, electric machine torque, suspension actuator position, and aerodynamic actuator position reach their positions that are based on the human operated input device position at time t3.

At time t4, the driver demand torque request is increased while the human operated input device is fully applied. The engine torque begins to increase so that the driver demand torque is delivered via the driveline to vehicle wheels while the electric machine consumes torque from the driveline to charge the traction battery according to the position of the human operated input device position. The engine torque increases at a same rate as the driver demand torque request. The electric machine torque is unchanged and it follows the human operated input device position so that the traction battery remains charging at a higher level. This allows the traction battery to reach full charge in a shorter amount of time so that if driver demand torque reaches a higher level, maximum torque is available from the electric machine. Likewise, the suspension actuator and the aerodynamic actuators continue to follow the position of the human operated input device.

At time t5, the driver demand torque request is increased at a higher rate while the human operated input device is fully applied. The engine torque begins to increase at a higher rate and it is at a level where electric machine torque magnitude begins to decrease so that the driver demand torque may be delivered via the driveline to vehicle wheels from the engine. The suspension actuator and the aerodynamic actuators continue to follow the position of the human operated input device.

At time t6, the driver demand torque request reaches its maximum. The engine torque output reaches its maximum and the electric machine torque output reaches its maximum torque in response to the driver demand torque request. Thus, the combined torque of the engine and the electric machine delivers the driver demand torque. However, since the driver demand torque is high, charging of the traction battery has ceased after torque of the electric machine crossed the horizontal axis. The suspension actuator and the aerodynamic actuators continue to follow the position of the human operated input device.

At time t7, the driver demand torque request begins to be reduced. This causes the engine torque and electric machine torque to be reduced so that engine torque plus electric machine torque produces the requested driver demand torque to the driveline. The human operated input device position is unchanged. The suspension actuator and the aerodynamic actuators continue to follow the position of the human operated input device.

At time t8, the driver demand torque request reaches zero and the human operated input device position begins to be reduced. At this time, the electric machine torque is now negative and the traction battery is charging. Reducing the human operated input device position causes the electric machine torque to be reduced in magnitude and the engine torque continues to be reduced. The torque delivered to the wheels is zero since the electric machine is consuming all of the torque that is generated via the engine. The suspension actuator position begins to be reduced and the aerodynamic actuator position begins to be reduced.

At time t9, the driver demand torque request is zero and the human operated input device position reaches zero. Therefore, the electric machine torque is now zero and the engine delivers zero driver demand torque to the driveline. The suspension actuator position and the aerodynamic actuator position reach their base positions.

In this way, suspension actuators and aerodynamic actuators may be adjusted according to a position of a human operated input device. Further, electric machine torque or charge output may be adjusted according to the position of the human operated input device. Output of the engine is adjusted so that driver demand is met. Thus, engine torque or power is adjusted independent of electric machine torque for at least a portion of the driver demand request. Further, electric machine charge capacity is adjusted independent of driver demand torque for at least a portion of the driver demand request.

Turning now to FIG. 4, a flowchart of a method for inhibiting and clearing inhibiting of automatic engine stops is shown. The method of FIG. 4 may be incorporated into and may cooperate with the system of FIGS. 1-2. Further, at least portions of the method of FIG. 4 may be incorporated as executable instructions stored in non-transitory memory while other portions of the method may be performed via a controller transforming operating states of devices and actuators in the physical world.

At 402, method 400 determines vehicle operating conditions. Vehicle operating conditions may be determined based on output from the vehicle’s various sensors and actuators as well as looking up values in functions or tables of data that are stored in controller memory. The vehicle operating conditions may include, but are not constrained to engine on/off state, vehicle speed thresholds, a position of a human operated input device, driver demand torque, transmission operating state (e.g., engaged in drive, engaged in reverse, engaged in neutral, etc.), ambient air temperature, vehicle speed, barometric pressure, and traction battery state of charge. Method 400 proceeds to 404.

At 404, method 400 judges whether or not a human operated input device (e.g., 276 of FIG. 2) is receiving input from a human. In one example, method 400 judges that there is human input to the human operated input device when the human operated input device is not in its base position. If method 400 judges that there is input to the human operated input device, the answer is yes and method 400 proceeds to 406. Otherwise, the answer is no and method 400 proceeds to 430.

At 406, method 400 judges whether or not the human operated input device allows bidirectional input and may include a base center position. Element 276 of FIG. 2 shows one example of such a human operated input device. The human operated input device may have an output that is proportionate to a position of the human operated input device. For example, the human operated input device may output a voltage, current, or numeric value that is proportionate to a position of a lever or pushbutton of the human operated input device. In one example, the configuration of the human operated input device is stored in controller memory. If method 400 judge that the human operated input device allows bidirectional input, the answer is yes and method 400 proceeds to 407. Otherwise, the answer is no and method 400 proceeds to 408.

At 407, method 400 adjusts torque or power output of an electric machine (e.g., 240) proportionate to a position of the bidirectional human operated input device in response to the position of the bidirectional human operated input device. Additionally, the operating mode of the electric machine may be adjusted in response to the position of the bidirectional human operated input device. For example, if the lever of human operated input device 276 of FIG. 2 is moved to the left (-), the electric mode is operated in a generator mode where it produces electric charge to charge the traction battery. On the other hand, if the human operated input device 276 of FIG. 2 is moved to the right (+), the electric machine is operated in motor mode such that it may provide torque to propel the vehicle. Also, the output of the electric machine may be adjusted proportionate to the position of the human operated input device. For example, if the human operated input device is moved to the right and to a position representing 25% of its range, the electric machine may be commanded to generate 25 Newton-meters. However, if the same human operated input device is moved to the right and to a position representing 100% of its range, the electric machine may be commanded to generate 100 Newton-meters. Thus, output of the electric machine may be adjusted independent of the driver demand pedal position and according to the position of the human operated input device. FIG. 5 shows one example of how output of the electric machine may be adjusted in response to human input to the human operated input device. Method 400 may also adjust output of the electric machine according to battery state of charge. Method 400 proceeds to 410.

At 408, method 400 adjusts a charging rate of a traction battery and/or output of an electric machine to charge the traction battery proportionate to input to the human operated input device. Further, method 400 may adjust output of the electric machine according to battery state of charge. In one example, method 400 may increase a rate of charging of the traction battery and increase charge output or current flow from the electric machine to charge the traction battery as a position of the human operated input device increases or moves away from a base position of the human operated input device. FIG. 6 shows one example of how the rate of charging of the traction battery or output of the electric machine may be increased in response to the position of the human operated input device. Method 400 proceeds to 410.

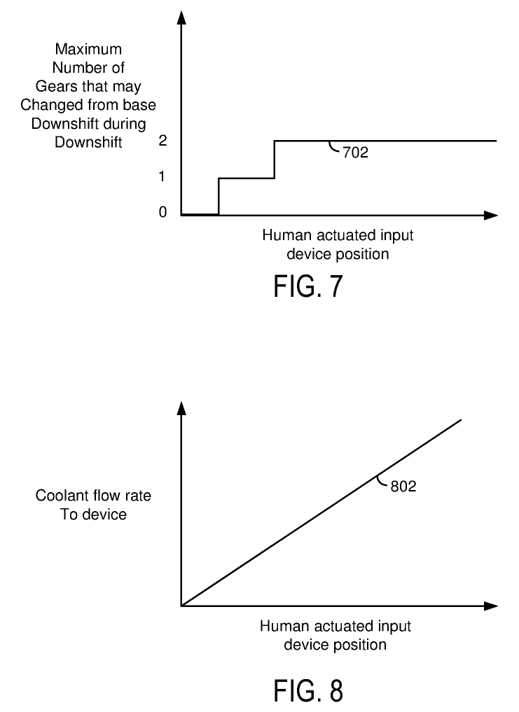

At 410, method 400 adjusts a transmission gear shifting schedule according to a position of the human operated input device. In one example, the transmission gear shifting schedule may increase an actual total numbers of transmission gears that may be skipped during a downshift according to a position of the human operated input device. For example, if the transmission is a ten speed transmission and the transmission is operating in eighth gear when driver demand is increased while the vehicle is traveling at one hundred kilometers/hour, the transmission may be allowed to downshift a maximum of one gear (e.g., from eighth gear to seventh gear) under baseline conditions when there is no input to the human operated input device. However, during the same conditions when there is input to the human operated input device, the transmission may be allowed to downshift a maximum of two transmission gears (e.g., from eighth gear to sixth gear). In one example, method 400 may adjust transmission shifting according to a function or relationship as shown in FIG. 7. Method 400 proceeds to 412.

At 412, method 400 adjusts traction battery, engine cooling, and ISG according to a relationship between input to the human operated input device and cooling of the traction battery, engine, and ISG. Cooling of the traction battery, engine, and ISG may be adjusted according to a relationship between device cooling and input to the human operated input device is shown in the example of FIG. 8. Method 400 proceeds to 414.

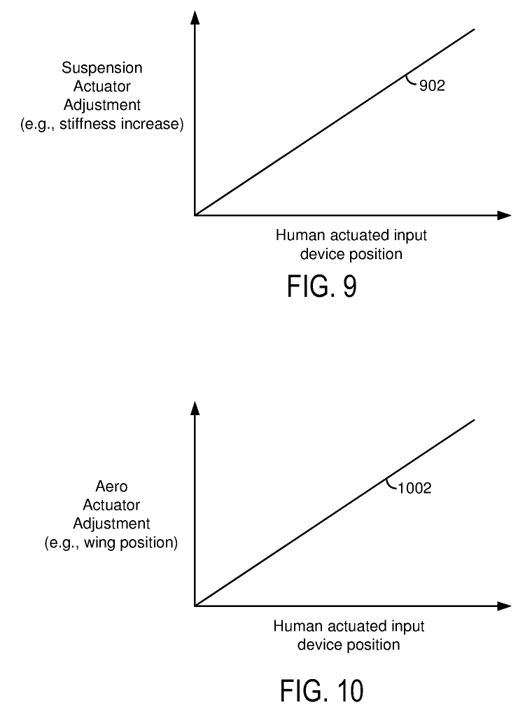

At 414, method 400 adjusts vehicle suspension actuators (e.g., shock absorbers, suspension lifting devices, suspension movement impeding devices, suspension stiffening devices, etc.) in response to a position of the human operated input device. In one example, adjustments to suspension actuators may be performed according to a relationship between input to the human operated input device and suspension actuators as shown in FIG. 9. Method 400 proceeds to 416.

At 416, method 400 adjusts vehicle aerodynamic actuators (e.g., wing actuators, air dam actuators, grill shutter actuators, spoiler actuators, air foils, etc.) in response to a position of the human operated input device. In one example, adjustments to vehicle aerodynamic actuators may be performed according to a relationship between input to the human operated input device and vehicle aerodynamic as shown in FIG. 10. Method 400 proceeds to 418.

At 418, method 400 adjusts electric machine output (e.g., torque or power) and internal combustion engine output (e.g., torque or power) to deliver the requested driver demand torque or power that has been input to the driver demand pedal. The driver demand takes priority over the traction battery charging torque or power. Therefore, if the internal combustion engine may meet the driver demand torque while providing torque or power to meet the electric machine output that has been requested via the human operated input device, the engine provides the torque or power to meet the driver demand torque and the electric machine mechanical input torque or power to meet the electric machine requested output. On the other hand, if the internal combustion engine may not meet the driver demand torque while providing torque or power to meet the electric machine output that has been requested via the human operated input device, the engine provides the torque or power to meet a portion of the driver demand torque and the electric machine may change from consuming mechanical torque from the driveline to delivering torque or power to the driveline to meet the driver demand torque. Method 400 proceeds to exit.

At 430, method 400 adjusts a charging rate of a traction battery and/or output of an electric machine to charge the traction battery according to one or more of a driver demand torque or power and a battery state of charge. In one example, one or more of battery state of charge and driver demand torque may be applied to reference a table that outputs an electric machine output for charging the traction battery according to one or more of battery state of charge and driver demand torque or power. Method 400 proceeds to 432.

At 432, method 400 adjusts a transmission gear shifting according to a base schedule. The base schedule may be referenced by driver demand torque or power and vehicle speed. The base schedule may output a gear that is to be engaged according to the present driver demand torque or power and vehicle speed. Values in the base schedule may be empirically determined via operating the vehicle and adjusting transmission gears so that the vehicle meets fuel economy, performance, and emissions objectives. Method 400 proceeds to 434.

At 434, method 400 adjusts traction battery, engine cooling, and ISG according to a base schedule. In one example, the base schedule may be based on driver demand torque or power. Values in the base schedule may be empirically determined via operating the vehicle and adjusting coolant flow rates as a function of driver demand torque or power so that desired engine, ISG, and battery temperatures may be maintained. Method 400 proceeds to 436.

At 436, method 400 adjusts vehicle suspension actuators (e.g., shock absorbers, suspension lifting devices, suspension movement impeding devices, suspension stiffening devices, etc.) and aerodynamic devices (e.g., air dams, air foils, spoilers, wings, etc.) in response to a vehicle operating mode (e.g., performance, economy, highway, etc.). Method 400 proceeds to 416.

At 438, method 400 adjusts electric machine output (e.g., torque or power) and internal combustion engine output (e.g., torque or power) to deliver the requested driver demand torque or power that has been input to the driver demand pedal. The driver demand takes priority over the traction battery charging torque or power. Therefore, if the internal combustion engine may meet the driver demand torque while providing torque or power to meet the electric machine output that has been requested via the human operated input device, the engine provides the torque or power to meet the driver demand torque and the electric machine mechanical input torque or power to meet the electric machine requested output. On the other hand, if the internal combustion engine may not meet the driver demand torque while providing torque or power to meet the electric machine output that has been requested via the human operated input device, the engine provides the torque or power to meet a portion of the driver demand torque and the electric machine may change from consuming mechanical torque from the driveline to delivering torque or power to the driveline to meet the driver demand torque. Method 400 proceeds to exit.

In this way, method 400 may adjust vehicle operation according to a driver demand pedal position (e.g., a driver demand torque or power request) and/or a second human operated input device. The human operated input device may be bidirectional (e.g., left and right or up and down) or unidirectional. The human operated input device may allow the electric machine output to be adjusted independently from the driver demand pedal.

The method of FIG. 4 provides for a method for operating a hybrid vehicle, comprising: receiving input to a controller via a first human operated input device; receiving input to the controller via a second human operated input device; adjusting a driver demand torque or power via the controller in response to output of the first human operated input device; and adjusting torque or power of an electric machine via the controller proportionate to an output of the second human operated input device. In a first example, the method includes where adjusting torque or power of the electric machine includes generating a positive torque or power according to a first position of the second human operated input device and generating a negative torque or power in response to a second position of the second human operated input device. In a second example that may include the first example, the method includes where the first human operated input device is a driver demand pedal. In a third example that may include one or both of the first and second examples, the method includes where the second human operated input device is a pushbutton or lever. In a fourth example that may include one or more of the first through third examples, the method further comprises increasing an amount of charge generated via the electric machine proportionate to the output of the second human operated input device. In a fifth example that may include one or more of the first through fourth examples, the method further comprises adjusting a suspension actuator in response to the output of the second human operated input device. In a sixth example that may include one or more of the first through fifth examples, the method further comprises adjusting an aerodynamic actuator in response to the output of the second human operated input device. In a seventh example that may include one or more of the first through sixth examples, the method further comprises adjusting transmission gear shifting in response to the output of the second human operated input device.

The method of FIG. 4 also provides for a method for operating a hybrid vehicle, comprising: via one or more controllers, adjusting a rate of coolant supplied to one or more of a traction battery, an internal combustion engine, and an electric machine in response to a position of a human operated input device other than a driver demand pedal; and via the one or more controllers, adjusting torque or power generated via an internal combustion engine and an electric machine according to a driver demand torque or power that is based on a position of the driver demand pedal. In a first example, the method further comprises adjusting a position of an aero dynamic control device according to the position of the human operated input device. In a second example that may include the first example, the method further comprises adjusting a position of a vehicle suspension control device according to the position of the human operated input device. In a third example that may include one or both of the first and second examples, the method further comprises adjusting a transmission shift schedule according to the position of the human operated input device. In a fourth example that may include one or more of the first through third examples, the method includes where adjusting torque or power generated via the internal combustion engine includes assigning a higher priority to generating the driver demand torque or power than a battery charging request.

Turning now to FIG. 5, a plot 500 that shows a relationship between a position of a bidirectional human operated input device and torque generated via an electric machine is shown. The horizontal axis represents position of the bidirectional human operated input device. The vertical axis represents torque generated via an electric machine in response to the position of the bidirectional human operated input device. Trace 502 represents the torque that is generated via the electric machine according to the position of the bidirectional human operated input device.

In this example, trace 502 shows that the electric machine may supply mechanical torque or power to the vehicle driveline when the bidirectional human operated input device is moved to the right of its center position. The center position for the horizontal axis corresponds to the position where the vertical axis intersects the horizontal axis. Trace 502 shows that the electric machine may consume mechanical torque or power from the vehicle driveline and generate electric power to supply charge to the vehicle’s traction battery when the bidirectional human operated input device is move to the left of its center position. The output of the electric machine is proportionate to the position of the bidirectional human operated input device.

Referring now to FIG. 6, a plot 600 that shows a relationship between a position of a human operated input device and torque generated via an electric machine is shown. The horizontal axis represents position of the human operated input device. The vertical axis represents torque generated via an electric machine in response to the position of the bidirectional human operated input device. Trace 602 represents the torque that is generated via the electric machine according to the position of the human operated input device.

In this example, trace 602 shows that the electric machine may supply mechanical torque or power to the vehicle driveline when the human operated input device is moved away from its base position. Trace 602 shows that the electric machine may consume mechanical torque or power from the vehicle driveline and generate electric power to supply charge to the vehicle’s traction battery when the human operated input device is moved away from its base position (where the vertical axis intersects the horizontal axis). The output of the electric machine is proportionate to the position of the human operated input device.

Referring now to FIG. 7, a plot 700 that shows a relationship between a position of a human operated input device and a maximum actual total number of transmission gears that may be changed from a base downshifting schedule is shown. The horizontal axis represents position of the human operated input device. The vertical axis represents a maximum actual total number of transmission gears that may be changed from a base downshifting schedule. Trace 702 represents the maximum actual total number of transmission gears that may be changed from a base downshifting schedule according to the position of the human operated input device.

Here, trace 702 shows that up to two additional gears may be dropped during a transmission downshift in response to when the human operated input device is moved away from its base position. Trace 702 shows that the zero additional gears may be dropped when the human operated input device is near its base position. However, up to two additional gears may be dropped when the human operated input device is nearly fully extended. Thus, if the transmission is being operated in eighth gear and a downshift is requested, the transmission may be downshifted a base number of gears (e.g., one gear) plus up to two additional gears when the human actuated input is extended to its maximum level and farthest away from its base position. Thus, for example, under these conditions, the transmission may be downshifted from eighth gear to fifth gear (down three gears), when the human actuated input is fully applied and a downshift is requested.

Referring now to FIG. 8, a plot 800 that shows a relationship between a position of a human operated input device and a coolant flow rate to a device (e.g., internal combustion engine, ISG (electric machine), traction battery, etc.). The horizontal axis represents position of the human operated input device. The vertical axis represents coolant flow rate to a device in response to the position of the human operated input device. Trace 802 represents the coolant flow rate to a device that is generated via a pump and/or a valve according to the position of the human operated input device.

In this example, trace 802 shows that the coolant flow rate to the device may increase as the human operated input device is moved away from its base position (e.g., the location where the vertical axis intersects the horizontal axis). The coolant flow rate is proportionate to the position of the human operated input device.

Referring now to FIG. 9, a plot 900 that shows a relationship between a position of a human operated input device and a vehicle suspension device operational state (e.g., adds to suspension stiffness, adds to vehicle suspension height, etc.). The horizontal axis represents position of the human operated input device. The vertical axis represents vehicle suspension device operational state. Trace 902 represents the vehicle suspension device operational state according to the position of the human operated input device.

In this example, trace 902 shows that the vehicle suspension stiffness and/or suspension height relative to ground may increase as the human operated input device is moved away from its base position (e.g., the location where the vertical axis intersects the horizontal axis). The vehicle suspension operational state change is proportionate to the position of the human operated input device.

Referring now to FIG. 10, a plot 1000 that shows a relationship between a position of a human operated input device and a vehicle aerodynamic actuator operational state (e.g., adds down force to vehicle, provides additional blockage to air flow under the vehicle, etc.). The horizontal axis represents position of the human operated input device. The vertical axis represents vehicle aerodynamic actuator operational state. Trace 1002 represents the vehicle aerodynamic actuator operational state according to the position of the human operated input device.

In this example, trace 1002 shows that the vehicle aerodynamic actuator operational state as the human operated input device is moved away from its base position (e.g., the location where the vertical axis intersects the horizontal axis). The aerodynamic actuator operational state change is proportionate to the position of the human operated input device.

Note that the example control and estimation routines included herein can be used with various engine and/or vehicle system configurations. The control methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations and/or functions may be repeatedly performed depending on the particular strategy being used. Further, at least a portion of the described actions, operations and/or functions may graphically represent code to be programmed into non-transitory memory of the computer readable storage medium in the control system. The control actions may also transform the operating state of one or more sensors or actuators in the physical world when the described actions are carried out by executing the instructions in a system including the various engine hardware components in combination with one or more controllers.

This concludes the description. The reading of it by those skilled in the art would bring to mind many alterations and modifications without departing from the spirit and the scope of the description. For example, single cylinder, I3, I4, I5, V6, V8, V10, and V12 engines operating in natural gas, gasoline, diesel, or alternative fuel configurations could use the present description to advantage.

1. A method for operating a hybrid vehicle, comprising:
receiving input to a controller via a first human operated input device;
receiving input to the controller via a second human operated input device;
adjusting a driver demand torque or power via the controller in response to output of the first human operated input device; and
adjusting torque or power of an electric machine via the controller proportionate to output of the second human operated input device.

2. The method of claim 1, where adjusting torque or power of the electric machine includes generating a positive torque or power according to a first position of the second human operated input device and generating a negative torque or power in response to a second position of the second human operated input device.

3. The method of claim 2, where the first human operated input device is a driver demand pedal.

4. The method of claim 3, where the second human operated input device is a pushbutton or lever.

5. The method of claim 1, further comprising increasing an amount of charge generated via the electric machine proportionate to the output of the second human operated input device.

6. The method of claim 1, further comprising adjusting a suspension actuator in response to the output of the second human operated input device.

7. The method of claim 1, further comprising adjusting an aerodynamic actuator in response to the output of the second human operated input device.

8. The method of claim 1, further comprising adjusting transmission gear shifting in response to the output of the second human operated input device.

9. A system, comprising:
a driver demand pedal;
a human operated input device;
an internal combustion engine;
an electric machine; and
one or more controllers including executable instructions stored in non-transitory memory that cause the one or more controllers to directly adjust operation of the electric machine in response to output of the human operated input device and adjust operation of the internal combustion engine to generate a driver demand torque or power that is transferred to a vehicle’s wheels in response to a position of the driver demand pedal.

10. The system of claim 9, where adjusting operation of the electric machine includes adjusting an operating mode of the electric machine.

11. The system of claim 10, where the operating mode is selected from one of a torque or power generating mode and an electric charge generating mode.

12. The system of claim 9, where adjusting operation of the electric machine includes adjusting output of the electric machine proportionate to the output of the human operated input device.

13. The system of claim 9, further comprising additional instructions to additionally adjust operation of the internal combustion engine according to torque or power generated via the electric machine.

14. The system of claim 9, where directly adjusting operation of the electric machine in response to output of the human operated input device includes the one or more controllers commanding an electric machine torque to increase charging of a traction battery as the human operated input device is moved away from a base position.

15. The system of claim 9, where adjusting operation of the internal combustion engine includes adjusting torque or power output of the internal combustion engine so as to produce the driver demand torque or power and an amount of power consumed via the electric machine.

16. A method for operating a hybrid vehicle, comprising:
via one or more controllers, adjusting a rate of coolant supplied to one or more of a traction battery, an internal combustion engine, and an electric machine in response to a position of a human operated input device other than a driver demand pedal; and
via the one or more controllers, adjusting torque or power generated via the internal combustion engine and the electric machine according to a driver demand torque or power that is based on driver demand pedal position.

17. The method of claim 16, further comprising adjusting an aero dynamic control device operating state according to the position of the human operated input device.

18. The method of claim 17, further comprising adjusting a vehicle suspension control device operating state according to the position of the human operated input device.

19. The method of claim 16, further comprising adjusting a transmission shift schedule according to the position of the human operated input device.

20. The method of claim 16, where adjusting torque or power generated via the internal combustion engine includes assigning a higher priority to generating the driver demand torque or power than a battery charging request.
